(19) United States
(12) Patent Application Publication
(10) Pub. No.: US 2006/0016338 A1
(43) Pub. Date: Jan. 26, 2006

(54) Air purifier for purifying the air drawn out of a space containing polluted air and into a space that is sealed off in an air-tight manner

(76) Inventor: Tivadar Foldi, Budapest (HU)

Correspondence Address: HERSHKOVITZ & ASSOCIATES, 1725 I STREET NW, SUITE 300, WASHINGTON, DC, 20006, US

(21) Appl. No.: 10/540,620

(22) PCT Filed: Dec. 23, 2003
(86) PCT No.: PCT/HU03/00109

§ 371 Date: Jun. 24, 2005

(30) Foreign Application Priority Data
Dec. 27, 2002 (HU) P0204505

(51) Int. Cl. B03C 3/011

(52) U.S. Cl. 96/64; 96/66

(57) ABSTRACT

The invention relates to an air-purifier comprising a insulating disc (9), which is placed inside a housing (6) on one side thereof and which has openings (10), and comprising an insulating end wall which is located on the other side of the housing (6) and which is provided with perforations (4). In addition, supporting tubes (8), which are parallel to the axis of the housing (6), and control electrodes, which are provided with a positive and negative charge, are placed inside said housing (6). The invention is characterized in that: the electrode system is placed inside the supporting tubes (8); the supporting tubes (8), on portions of their lateral surfaces located opposite the end wall (5), are encircled by a screen (7) that has a low air resistance, and; the space between the supporting tubes (8) is filled with filter insert means (16).

Air cleaning device from air polluted space into closed space, especially for cleaning air breathed in by living organism, in the preferably axially symmetric house of which device there is an insulating disc with openings for introducing polluted air on its one side orthogonal to the axis of the house situated at the atmospheric side, and also, there is a perforated insulating front surface on the other side of the house orthogonal to the axis opposite to the insulating disc at the user side, further, there are supporting tubes situated parallel to the axis acting as a boundary for the air flow, and there are positively and negatively charged scattering electrode wires.

It is known that gas was first used in military actions in the first world war so as to obstruct military actions of the enemy, and the so called gas-masks were developed as a means of defence against it. These devices are manufactured with parameters that must comply with the most stringent standards even in our days. In the first times the gas-masks comprised a disguise-like mask covering the face with air-tight sealing, and were provided with an air filter in front of the nose and the mouth placed in a usually cylindrical house, and the air cleaned by the filter could get to the respiratory organs only through this filter.

Due to the development of technology, the quality of the gases applied changed, and the filters must have been always designed to according to the new challenges in order that the efficiency of filtering and the lifetime of the filter should meet the specified minimum requirements. However, it resulted in such an increase in the weight of the filter that using the uncomfortable gas-masks became nearly intolerable.

This problem was to be eliminated by the construction where the filter was mounted to an other part of the body and the cleaned air was conducted to the mouth opening of the mask through a flexible goose neck.

As the development of the quality of filters could not step up with the quality requirements against the filters, these constructions could meet the above mentioned requirements only by increasing the mass of the filters. It is a further problem that even the quality requirements became more and more stringent. It was shown that the gases to be filtered contain pollution in the form of dust in a very wide range. The diameter of the dust particles getting into the filter range between 20 mm and 0,001 mm, as the radioactive decay products are of molecular size, and metallic decay products act like gas pollution. In spite of this fact, these decay products are referred to as dust. However, the filters applied in the gas-masks in our days are able to filter out dust particles with a diameter exceeding 0.3 mm. It is already known that dust particles of this size are the most harmful for living organisms. The cells in the alveoli of the lung enclose these dust particles and they can not be removed from the organism by the usual cleaning methods.

It is a common feature of the filters in the gas-masks that the air is flowed by the aspiration of the living organism, and therefore their resultant air resistance must not exceed a certain maximum value that would make the breathing of the living organism significantly harder.

It is also known that in the electrostatic dust separators the medium carried by the gas flow is charged up by electric charges, than this charged medium is flown through electric field, where it is separated. It is an advantage of this method that the majority of organisms, bacteria and viruses carried by the polluted air is also destroyed, therefore it is also suitable for biological defence. It is a disadvantage that usually their space demand is significant.

There are also known dust separators where the polluted air flows swirling in a downwards narrowing space and the particles touching the boundary wall of circular cross section lose their angular momentum and fall down to the bottom of the space. These are the so called cyclone dust separators. However, the space demand of these devices increase with the required increase in the rate of rotation, and they are able to separate only a small fraction of the floating particles.

It was the purpose of the construction presented in patent specification HU 193 944 to eliminate this drawback, which construction combined the electrostatic and cyclone dust separators and the advantages thereof, and made it possible to construct dust separators of smaller volume. The spinning motion is generated by wing-shaped electrodes (which are plume shaped in cross section). The polluted air is introduced in a tube coaxial with the cylindrical house and the air gets inside the house through the air holes on the curved surface of the tube. The alternately positively and negatively charged air channelling electrodes of circular configuration generate an asymmetric force field and increase the rotation of the air through nearly the entire length of the house. The scattering electrodes are situated between the air channelling electrodes and they are of the opposite potential than the nearmost air channelling electrodes, and are also arranged in circular configuration. This construction allowed a significant reduction in size and therefore it was suitable for cleaning diesel soot as well. However, it was a disadvantage of this construction that due to the small distance between the wing-shaped air-channelling electrodes and the scattering electrodes there was an increased risk of spark-over, while if the applied voltage was reduced, the ionisation current was not sufficient.

A further development is presented in patent specification HU P 01 04988, where there is a hollow electrode of drop-shaped cross section, the polluted air is flown through the electrode and let out through a slit formed along the entire length of the hollow electrode, cutting the edge passing through the cusp of the drop-shaped cross section, and further, the scattering electrode is positioned at the outlet edge of the convex outside wall of the hollow electrode, and therefore, due to the high exit speed of the air, the ions are concentrated at the scattering electrode, and the ions are removed from the vicinity of the outlet edge, and so the required ionization current can be achieved even at lower voltage.

This construction reduces the space demand significantly, especially if applied with a rough pre-filter and with a traditional paper filter and/or gas filter at its output, while it is capable of filtering out even the smallest particles. Though it is the smallest one from the electrostatic air cleaning devices of similar capacity, it is still too large for being used as an individual filter in a gas-mask, even if in individual filters there is no need for ventilating fan carrying the polluted air.

It is the object of the invention to create an electrostatic air filter that keeps the quality of the known electrostatic air filters while it is suitable for being connected directly or at least indirectly to traditional gas-mask filters and to increase the working life of the air filter, while neither its weight nor its air resistance is so big as to obstruct the user in its actions.

The fundamental idea of the invention is that if the electrodes are positioned inside a conducting cylinder and the temperature of the electrodes is increased above the temperature of the environment using extra-low voltage, the ionization current can be increased with orders of magnitude without generating electric spark-over between the electrodes. This result is obtained as a combined effect of quasi-thermic heating and field emission.

The essence of the invention is that the electrode system generating the electric field is situated inside supporting tubes made of electrically conducting material that can be connected to 0 potential, and further, the entire curved surface of the supporting tubes or at least their portion close to the front surface is covered with screen of low air resistance allowing diffuse flow, while the space in the house between the supporting tubes is filled with filter insert medium.

The scattering electrodes of the presently known electrostatic filters operate on the basis of field emission effect, while the electron tubes operate on the basis of thermoemission. There is no device operating on the basis of thermoemission at atmospheric pressure. With individual air filters, the user of the filter aspirates the air at significantly lower speed than with collective filters where the speed of the injected air depends on the air carrying capacity of the ventilating fan. It means that with individual filters, the mechanical stress on the electrode wires is significantly lower, and this fact made it possible to place the electrode wires in the air flow. Due to the low speed of air, the required heating power is lower.

The invention is described in more detail with reference to the embodiments shown in the drawings, where

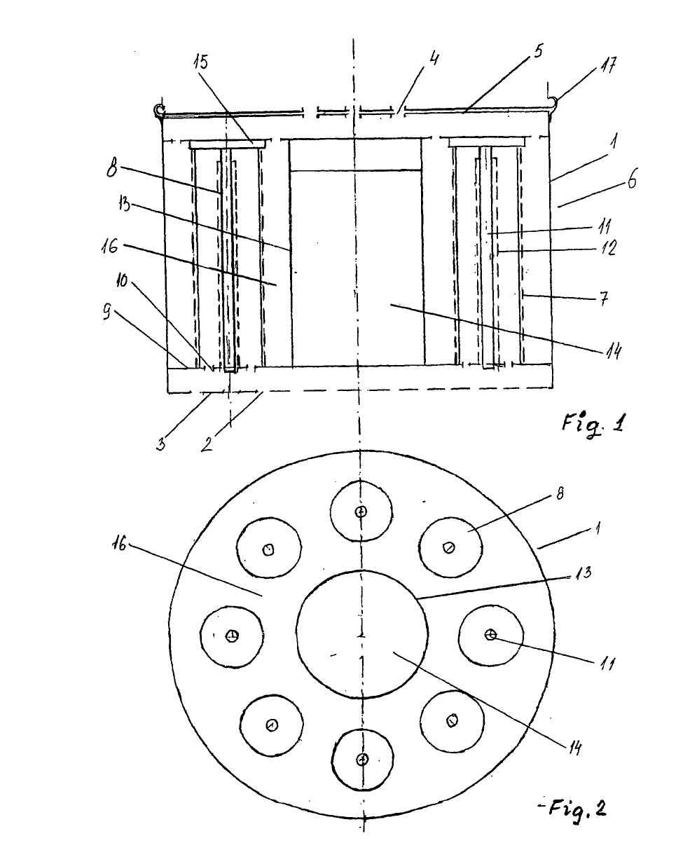

FIG. 1 shows the axial section of a draft of the embodiment of the air filter device according to the invention applicable as a cylindrical supplementary unit to be connected to traditional gas-masks, while

FIG. 2 shows section A-A of the air filter device shown in FIG. 1.

The air filter device shown in FIG. 1 has a cylindrical house 6 bordered by a closed (non air-permeable) curved surface 1, a front wall 3 on the atmospheric side provided with openings 2 for aspirating the incoming polluted air, apart from which openings the front wall 3 is closed, and a front surface 5 on the user side provided with perforations 4 for letting through the outgoing air, apart from which perforations the front surface 5 is closed.

In the house, in axial symmetric configuration, there are supporting tubes 8 with their axes parallel to the axis of the house 6, with perforated walls preferably made of plastic, with their curved surfaces coated with preferably woven conducting screen 7. The plastic wall and/or the screen 7 is made of conducting material that can be connected to 0 potential. The supporting tubes 8 are fixed to the insulating disc 9 situated parallel to the front wall 3 on the atmospheric side, preferably they are fitted into the circular grooves formed on the insulating disc 9. There are openings 10 on the insulating disc 9 for introducing the polluted air coming through the openings 2 into the inner part of the supporting tubes 8. Inside the supporting tubes 8 there are electrode holders 11, preferably cylindrical electrode holders 11 made of plastic, arranged coaxially with the supporting tubes 8, and there are even-numbered scattering electrode wires 12 arranged in circular symmetric configuration on the curved surface of the electrode holders 11, parallel to the axis of the electrode holder 11. Every two scattering electrode wires 12 situated opposite to each other are connected to each other somewhere near the end of the electrode holder 11 close to the front surface 5 at the user side. According to the example, the electrode holder 11 is directed through the insulating disc 9, and also, the scattering electrode wires 12 are connected to the electronic power supply 14 after crossing the insulating disc 9, which power supply 14 is situated in the axis of the house 6 insulated preferably air-tight from the other parts of the house 6 by the inside bordering wall 13. The surface of the screen 7 can be made electrically conductive e.g. by vacuum spraying.

At their end at the front surface on the user side, the supporting tubes 8 are closed air-tight by the separate front disc 15 or by being connected directly to the front surface 5. The electrode holders 11 are also connected to the front disc 15 or to the front surface 5 so as to stabilize their position.

The parts of the house 6 outside the supporting tubes 8 and the bordering wall 13 are filled with the filter insert medium 16, and the perforations 4 on the front surface 5 on the user side are situated on the surface of the front surface 5 adjoining the filter insert medium 16. On the curved surface 1, close to the front surface 5, there is a quick connection mechanism for establishing connection to the input of traditional gas-mask filter inserts, e.g. a spring type clamp joint mechanism 17 or a bayonet catch.

The air cleaning device according to the invention operates as follows:

The polluted air gets through the openings 2 of the front wall 3 than through the holes 10 of the insulating disc 9 into the inner part of the supporting tube 8 constituting the “active zone”. The scattering electrode wires 12 are connected to the extra-low voltage outputs of the electronic power supply 14 in the space between the front wall 3 and the insulating disc 9 in a way that the charge of the adjacent electrode wires 12 are the opposite to each other. As the first step of chemical reactions in the active zone controlled redox processes take place. This is effective in the range of molecular size pollutions as well, resulting in approximately 1:5 rate decrease in the concentration.

In the active zone the component of the ion velocity orthogonal to the axis is significantly higher than the average axial velocity of the air to be cleaned, so the double layer on the surface of bacteria is broken, the plasma of the bacteria is damaged and the living organism dies.

The air partly cleaned this way gets into the filter insert medium 16 through the screen 7 and the supporting tube 8. In the meantime, the dust particles in the air coagulate and the maximum of the dust distribution curve moves up by about one order of magnitude from the biologically most harmful zone, which significantly increases the filtering time of the dust filter paper in traditional gas filter inserts, so the so called breakdown time is increased. E.g. if the breakdown time is increased by a factor of 1:10, it means that the user of the gas mask can use the gas filter for 20 hours instead of the presently typically permitted 2 hours, so he can spend ten times more time in the polluted area than until now.

In case of radioactive dusts the pollution particles of larger diameter getting into the lungs can be discharged by the natural cleaning mechanisms and the radiation exposure is reduced significantly. This way it can be avoided that the most harmful components close the pores of the alveoli in the lungs.

1-8. (canceled)

9. Air cleaning device from air polluted space into closed space, especially for cleaning air breathed in by living organism, in the preferably axially symmetric house of which device there is an insulating disc with openings for introducing polluted air on its one side orthogonal to the axis of the house situated at the atmospheric side, and also, there is a perforated insulating front surface on the other side of the house orthogonal to the axis opposite to the insulating disc at the user side, further, there are supporting tubes situated parallel to the axis acting as a boundary for the air flow, and there are positively and negatively charged scattering electrode wires, wherein:
the electrode system generating the electric field is situated inside supporting tubes (8) made of electrically conducting material that can be connected to 0 potential, and further, the entire curved surface of the supporting tubes (8) or at least their portion close to the front surface (5) is covered with screen (7) of low air resistance allowing diffuse flow, while the space in the house (6) between the supporting tubes (8) is filled with filter insert medium (16).

10. Air cleaning device according to claim 9, wherein the supporting tubes (8) are fixed to the insulating disc (9) situated parallel to the front wall (3) on the atmospheric side, preferably they are fitted into the circular grooves formed on the insulating disc (9).

11. Air cleaning device according to claim 9, wherein inside each supporting tube (8), there is an electrode holder (11), preferably cylindrical electrode holder (11) made of plastic, arranged coaxially with the supporting tube (8).

12. Air cleaning device according to claim 11, wherein there are even-numbered scattering electrode wires (12) arranged in circular symmetric configuration on the curved surface of the electrode holders (11), parallel to the axis of the electrode holder (11), and the scattering electrode wires (12) are connected to the electronic power supply (14) after crossing the insulating disc (9).

13. Air cleaning device according to claim 12, wherein the electronic power supply (14) is situated in the axis of the house (6) insulated air-tight from the other parts of the house (6) preferably by the inside bordering wall (13).

14. Air cleaning device according to any of claim 9, wherein at their end at the front surface (5) on the user side, the supporting tubes (8) are closed air-tight by the separate front disc (15) or by being connected directly to the front surface (5).

15. Air cleaning device according to claim 14, wherein the ends of the electrode holders (11) on the user side are connected to the front disc (15) or to the front surface (5).

16. Air cleaning device according to claim 9, wherein the screen (7) is made electrically conductive by vacuum spraying.
